(19) United States
(12) Patent Application Publication
(10) Pub. No.: US 2003/0091716 A1
(43) Pub. Date: May 15, 2003

(54) Stable homogeneous drink composition including particulate cereal product

(76) Inventors: Simpey Kuramoto, Ramsey, NJ (US); Deborah Boudreau, Fort Lee, NJ (US); C. A. McCampbell, Stafford, NY (US)

Correspondence Address: Stephen B. Salai, Esq., Harter, Secrest & Emery LLP, 1600 Bausch & Lomb Place, Rochester, NY, 14604-2711, US

(21) Appl. No.: 10/037,821

(22) Filed: Nov. 9, 2001

(51) Int. Cl. A23C 1/00

(52) U.S. Cl. 426/580

(57) ABSTRACT

A ready-to-drink stable and homogeneous drink composition has particulated ready-to-eat cereal product in a liquid carrier. The drink mix composition can incorporate milk or milk-type products as the liquid carrier in either a refrigerated or shelf stable non-refrigerated format, wherein food stabilizers can be added.

### FIELD OF THE INVENTION

The present invention relates to stable homogeneous drink compositions, and more particularly, to stable homogeneous drinks including particulated cereal product, wherein the drink retains an original aroma and taste of the cereal product.

### BACKGROUND OF THE INVENTION

U.S. Pat. No. 5,686,123 discloses a homogeneous and stable cereal suspension, wherein a suspension of wet, ground or heat and water treated oats is suspended in water to produce a mixture containing intact beta glucans from the starting material. However, while this product may be used as a basis or additive to ice cream, milk shakes and health drinks, it does not provide a consumer recognizable or identifiable taste typically sufficient to initiate purchase of the product.

However, the need exists for a stable and homogeneous drink composition, which can incorporate and retain known commercially available cereal product flavors without jeopardizing the inherent nutritional value of the cereal product. The need also exists for a drink composition that includes dairy products such as milk.

### SUMMARY OF THE INVENTION

The present invention provides a stable homogeneous drink composition, which can incorporate a commercially available, ready to eat cereal product. Specifically, the present drink composition includes a homogenized blend of cereal product particulates, a food stabilizer and a liquid carrier. In an alternative configuration, the drink composition includes a homogeneous blend of cereal product particulates and milk, wherein the milk can include a variety of milk and milk based liquids.

In further configurations, the drink composition can include additives such as flavorings, colorings, vitamins, minerals and sweeteners. The present composition can also include food stabilizers for enhancing the suspension of the cereal product particulates in the liquid carrier.

It is also contemplated the drink composition can be provided in a dry admix state, wherein the admix is combined with a liquid by the user. The dry admix includes the particulated cereal product and the food stabilizer. The dry admix can be formed to include a powdered milk.

### BRIEF DESCRIPTION OF THE DRAWINGS

FIG. 1 is a flow chart of the formation of the drink mix composition.

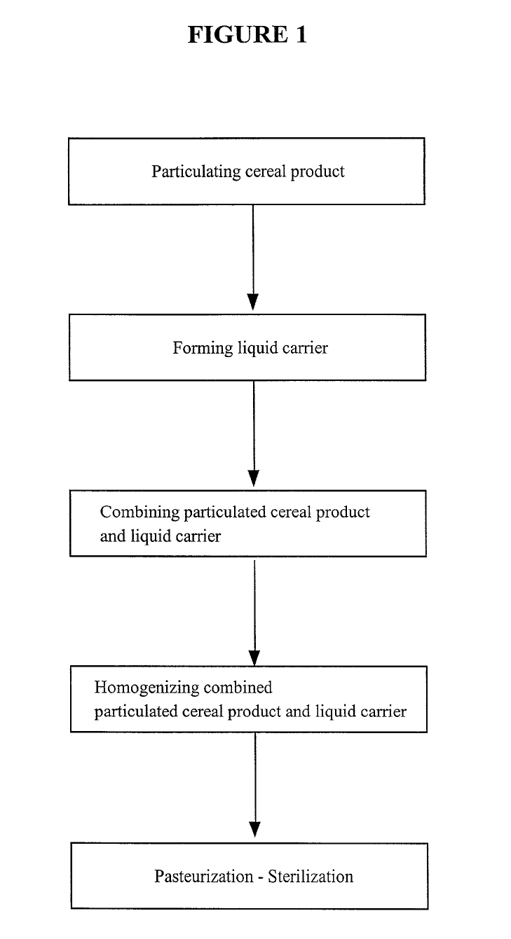

FIG. 2 is a flow chart of the formation of the particulated cereal product.

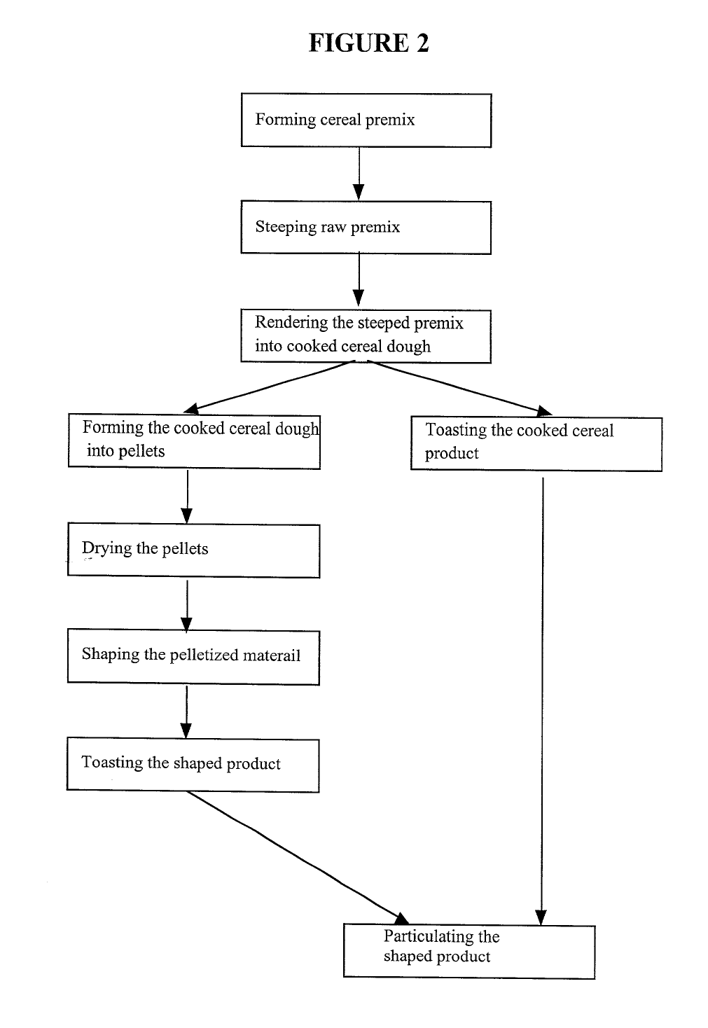

### DETAILED DESCRIPTION OF THE PREFERRED EMBODIMENTS

The present invention provides a drink mix composition including a homogeneous blend of cereal product particulates, a food stabilizer and a liquid carrier.

Cereal Product

As used herein, the term “cereal product” encompasses any of a variety of grains including, but not limited to wheat, rye, rye-wheat, barley, oats, corn, rice, millets, and sorghum, which have been precooked or processed to provide a ready-to-eat cereal product. Typically, these cereal products are customarily combined with milk or cream for breakfast and are often sweetened with sugar, syrup or fruit.

The contemplated cereal products include but are not limited to Kellogg's Corn Flakes®, Raisin Bran®, Wheaties® and Cheerios®, ready-to-eat cereals, as well as generic brands. The cereal products can also include ready-to-eat cereal products such as granola and oat-based products.

The brand name cereal products are specifically created to have a distinct and recognized flavor and aroma. Generic or competing brands often attempt to mimic the flavor and aroma of the brand name products. It is understood any of these cereal products can be employ in the present invention.

The term cereal product includes processed ready-to-eat cereals as well as cereal substrates, typically existing as an intermediate form in the ready-to-eat cereal manufacturing process. Specifically, raw grains can be sufficiently processed without complete formation into the commercially available format, wherein such processed grains can be employed as the present cereal product. Typical processing includes cleaning, cooking, drying, milling and toasting the grains. U.S. Pat. No. 6,291,008 describes a process for forming a ready to eat cereal, and is hereby expressly incorporated by reference. It is understood each of these steps can be modified without departing from the invention. For example, the toasting step can encompass the inclusion of carbohydrates, such as but not limited to glucose and peptides, such as but not limited to amino acids for enhancing the resulting toasted flavor.

In a preferred configuration, the cereal product is toasted, wherein the form of the toasted cereal product is not significant, as the cereal product is particulated for inclusion in the drink composition. That is, the toasting of the cereal product can occur prior or subsequent to the formation of the cereal product particulates.

Cereal products have developed to enhance nutritional value as well as provide health benefits. The present use of the cereal products does not diminish the established nutritional benefit of the cereal product. As subsequently described, the present invention retains the nutritional value of the cereal product.

Liquid Carrier

The liquid carrier can be any of a variety of liquids, including but not limited to, milk and milk products such as, cream, whole milk, reduced fat milk and skim or fat free milk. The term milk includes the whitish liquid containing proteins, fats, lactose, and various vitamins and minerals that is produced by the mammary glands of mature female mammals and serves as nourishment for their young. Milk can include that of cows, sheep, goats, buffalo, llama, yak or other animals. The milk product can also be cultured or fermented, including but not limited to yogurt and function as the liquid carrier in the present application.

It is also understood the term milk includes liquid milk type products derived from plants, such as beans and rice including soy milk, rice milk, coconut milk or other plant derivative liquid that is similar to milk in appearance.

It is also contemplated the liquid carrier can include a fruit based product including juices, juice derivatives or combinations thereof.

Depending upon the particular composition of the present drink, a food stabilizer can be included. The food stabilizer enhances smoothness of the resulting composition. A preferred food stabilizer is micro-crystalline alpha cellulose, sold under the trade name Avicel® by the FMC Corporation of Pennsylvania. However, other commercially available food stabilizers can be used. For example, available food stabilizers include, but are not limited to gelatin, pectin, xanthan, guar, gum arabic, gum tragacanth, and carageenan.

The drink composition can include additional flavoring and sweetening additives. The flavorings can be natural or artificial and include, but are not limited to any of a variety of commercially available flavorings such as vanilla, cocoa, marshmallow, honey-nut, banana, strawberry, cherry, raspberry, blueberry, melon, fruit flavors and chocolate marshmallow.

The sweetening additives include sweeteners such as cane sugar, corn syrup or sugar, or honey. The sweeteners can be employed from a crystal, dry, powder, liquid or syrup form, without departing from the present invention. Supplemental nutritive carbohydrate sweeteners can be additionally included such as, for example, sucrose, fructose, glucose, maple syrup solids, fruit juice solids, and mixtures thereof. It is also understood artificial sweeteners can be employed.

The present drink composition retains the health benefits of the underlying cereal product. For example, Cheerios® brand cereal has been clinically proven to help lower blood cholesterol when eaten as a part of a diet low in saturated fat and cholesterol. Cheerios® brand cereal is a natural source of soluble fiber, wherein studies have shown that soluble fiber from oats, as part of a low fat diet, has a special ability to lower blood cholesterol levels, which in turn may decrease the risk of heart disease.

A typical embodiment of the drink composition includes 2 to 10 percent by weight cereal product, 70 to 95 percent by weight liquid carrier such as milk, 0.1 to 5 percent by weight stabilizer; 1 to 10 percent by weight sugar and less than 1 to 10 percent by weight flavorings, which percentage is at least partially determined by the concentration of the commercially available flavor. Preferably, a single serving of the drink composition includes at least a single serving of the cereal product. A typical ready to eat cereal serving size is 1 oz. Therefore, for a 10 oz. or greater drink composition, the 2 to 10% by weight cereal product can provide the benefits of a single serving of the cereal product. It is understood the percentage of cereal product can be selected to provide more than or less than a single serving size of cereal product for a given serving size of the drink composition. Thus, the percentage by weight of cereal product may be as high as 25%. The upper limit of the percentage by weight cereal product is generally dictated by the desired viscosity (as well as mouth feel) of the resulting drink composition.

Additional flavor profiles include, but are not limited to natural and artificial vanilla, marshmallow, honey nut, chocolate and chocolate marshmallow. It is understood the present invention is independent of the flavor profile. That is, while preferred formulations retain the flavor and aroma of well recognized and consumer popular cereal products, the drink can be formulated to exhibit a varied flavor and aroma.

In a preferred embodiment, the liquid carrier is milk and thus the drink composition effectively reproduces the nutritional value as well as the flavor and aroma of a traditional bowl of cereal. Preferably, the particulate cereal product is substantially insoluble in the liquid carrier. That is, the resulting drink includes insoluble particulates of the cereal product suspended in the liquid carrier.

In an alternative configuration, the drink composition can be formed by the end user, or consumer. Specifically, the consumer could add a packet of dry admix to a volume of liquid carrier. In this configuration, the stabilizer, flavorings and other additives are admixed and packaged for subsequent use. The dry admix could be distributed in individual serving sizes, or bulk containers for user determined concentrations with the user selected liquid carrier.

The dry admix configuration of the invention includes the cereal product particulates, the flavorings and/or sweeteners if desired, and the food stabilizer. It is understood the dry admix can include various nutritional additives as well, including but not limited, to minerals and vitamins.

An alternative configuration of the dry admix includes a dehydrated liquid carrier base such as a milk product. A typical dehydrated liquid carrier is powdered milk. The powdered milk comprises dried whole milk or a low-fat dry milk or dry milk substitute product. Dried skim milk or non-fat milk products can also be used. Milk substitutes such as whey or soy can be added to the non-fat milk products to enhance their flavor and appearance. A suitable powdered milk is the low fat dry milk product sold by O-AT-KA Milk Products Cooperative, Inc. Corporation.

Commercially available dried milk products, including that noted above, are generally granular to avoid lumping and to obtain rapid dissolution when added to water.

The powdered milk can be added to the remaining dry ingredients to form the dry admix. Thus, the dry admix can be combined with water to provide a nutritious milk based drink composition.

Method

The cereal product is typically ground, pulverized or milled to an average particle size less than approximately 100 microns. Preferably, the particle size is between approximately 10 microns to approximately 60 microns. However, it is understood the specific particle size is at least partially determined by the desired mouth feel of the product. Preferably, the majority of the particles are sized to be within two standard deviations of the selected mean particle size. It is also understood the milling can include colloid milling, high energy dispersers, sound wave technology. The specific process is selected to stabilize the insoluble cereal product particulates in the liquid carrier.

The dry ingredients including the particularized cereal product and any dry flavorings or sugar are added to the liquid carrier. However, as previously set forth, the dry admix can be formed to include these dry ingredients with the powdered milk.

The method of forming the drink includes metering an initial water volume to a batch processor. Preferably, the metered water is sufficiently heated to maintain any subsequent solubilized additives. The particular temperature of the water is thus at least partially determined by the subsequent solubilized additives. A typical temperature range for the water is between approximately 120° F. to 140° F.

The food stabilizer, buffers and emulsifiers are solubilized with high-speed agitation. The degree and amount of agitation is at least partially determined by the specific type of stabilizer, buffers and emulsifiers. Typical agitation cycles are on the order of 5 to 10 minutes. The agitation produces a shear sufficient to form a dispersed mixture. As set forth in the description of the drink, the liquid carrier can be any of the variety of milk or milk type products.

Depending on the specific processing equipment, separate liquifiers and batch processors can be employed. Typically, the liquifier is employed to introduce the particulate cereal product; any vitamin or mineral premix, if required; any heat stable flavors, if required; any sweeteners, dairy or non-dairy ingredients, protein concentrates or isolates, if required; and other carbohydrates and additional fiber, if required.

The dry ingredients must be thoroughly dispersed in the liquid carrier. The required mixing time is at least partially determined by the equipment used, the batch volume and the specific formulation. Subsequently, the mixture is preheated and homogenized, preferably to a uniform consistency.

For a refrigerated version of the drink composition, the drink is cooled to less than 45° F. after being preheated, homogenized and pasteurized, and maintained at that temperature throughout distribution. The drink composition can be transferred to containers which include but are not limited to single or multiple serving containers such as gable top containers and plastic PET containers. However, the invention is not limited to the particular type of container.

Alternatively, for the version of the drink composition for non-refrigerated shelf stable storage, two types of packages are available, (i) retort (in container sterilization), or (ii) aseptic (drink and container are sterilized in separate systems. The retorted product must be filled and hermetically sealed in a container and subjected to a sterilization process which includes high temperature treatment, such as at about 121° C. for 8 to about 30 minutes. In the aseptic process the product must be heated to about 135° C. to about 150° C. for about 2 to about 10 seconds (UHT) and aseptically filled. In this system with approved sterilization process room-temperature storage is possible when used in conjunction with aseptic processing and packaging.

Although the present processing steps provide a method of manufacturing the drink composition, it is understood the processing steps can be varied without departing from the invention. For example, the specific processing temperatures and times are at least partially dependent upon the particular components, such as the cereal product and the liquid carrier. Thus, in a preferred implementation, the resulting drink composition is a homogenized stable beverage having particulate cereal product.

The present drink composition provides a readily portable drink that includes and retains the original nutritional value of the cereal product, prior to processing into the drink mix composition. In addition, the drink composition provides the benefits associated with the liquid carrier such as milk or soy products. Further, as the drink composition may be presented at a retail level in either a refrigerated or non-refrigerated form, the composition provides a wide variety of applications.

While a preferred embodiment of the invention has been shown and described with particularity, it will be appreciated that various changes and modifications may suggest themselves to one having ordinary skill in the art upon being apprised of the present invention. It is intended to encompass all such changes and modifications as fall within the scope and spirit of the appended claims.

The invention claimed is:

1. A drink mix composition, comprising a homogenized blend of cereal product particulates and milk.

2. The drink mix composition of claim 1, wherein the homogenized blend includes a food stabilizer.

3. The drink mix composition of claim 2, wherein the food stabilizer is one of a micro-crystalline cellulose, gelatin, pectin, xanthan, guar, gum arabic, gum tragacanth, and carageenan.

4. The drink mix composition of claim 1, wherein the cereal product particulates are a ready-to-eat cereal.

5. The drink mix composition of claim 1, wherein the homogenized blend is a stable suspension.

6. The drink mix composition of claim 1, wherein the milk is one of fat free and reduced fat.

7. The drink mix composition of claim 1, wherein the cereal product particulates are toasted.

8. The drink mix composition of claim 1, wherein the composition is pasteurized.

9. The drink mix composition of claim 1, wherein the cereal product particulates are insoluble in the liquid carrier.

10. A drink mix composition, comprising a homogenized blend of cereal product particulates, a food stabilizer and a liquid carrier.

11. The drink mix composition of claim 10, wherein the food stabilizer is one of a micro-crystalline cellulose, gelatin, pectin, xanthan, guar, gum arabic, gum tragacanth, and carageenan.

12. The drink mix composition of claim 10, wherein the liquid carrier includes one of milk, soy, and fruit juice.

13. The drink mix composition of claim 10, further comprising an added sugar.

14. The drink mix composition of claim 10, further comprising an added or natural or artificial flavoring.

15. The drink mix composition of claim 10, further comprising toasted cereal product particulates.

16. The drink mix composition of claim 10, wherein the composition is pasteurized.

17. The drink mix composition of claim 10, wherein the cereal product particulates are insoluble in the liquid carrier.

18. The drink mix composition of claim 10, further comprising a single serving container retaining a volume of the drink mix composition.

19. The drink mix composition of claim 10, wherein the cereal product particulates are 2 to 10 percent by weight of the drink mix composition.

20. A ready to consume liquid food drink, comprising:
(a) a container having a user operable closure mechanism;
(b) a particulated cereal product;
(c) a stabilizer; and
(d) milk.

21. The liquid food drink of claim 20, wherein the stabilizer is a microcrystalline cellulose.

22. The liquid food drink of claim 20, wherein the milk is fat free.

23. The liquid food drink of claim 20, wherein the milk has a reduced fat content.

24. The liquid food drink of claim 20, wherein the container is a single serving size.

25. The liquid food drink of claim 20, wherein the container includes multiple servings.

26. The liquid food drink of claim 20, wherein the milk, the particulated cereal product and the stabilizer are homogenized.

27. The liquid food drink of claim 20, wherein the milk, the particulated cereal product and the stabilizer are pasteurized.

28. The liquid food drink of claim 20, wherein the particulated cereal product is toasted.

29. The liquid food drink of claim 20, wherein the particulated cereal product is insoluble in the milk.

30. A method of forming a drink composition, comprising:
(a) reducing a cereal product to an average particle size less than 100 microns;
(b) adding a stabilizer to a volume of milk;
(c) combining the ready-to-eat cereal particles with the stabilizer and milk mixture; and
(d) homogenizing the cereal particles, stabilizer and milk.

31. The method of claim 30, further comprising toasting the cereal product prior to the combining step.

32. The method of claim 30, further comprising pasteurizing the homogenized cereal particles, stabilizer and milk.

33. A food product mix for forming a drink composition, comprising:
(a) a particulated toasted cereal product, the particulates having an average size less than 100 microns; and
(b) a food stabilizer.

34. The food product mix of claim 33, further comprising an added sweetener.

35. The food product mix of claim 33, further comprising a dehydrated milk product.
